(19) United States
(12) Patent Application Publication
(10) Pub. No.: US 2002/0111910 A1
(43) Pub. Date: Aug. 15, 2002

(54) Method and facility for preserving internet privacy

(75) Inventor: Fiona Walsh, Seattle, WA (US)

Correspondence Address: Bennet K. Langlotz PC, 2850 SW Fairmount Blvd., Portland, OR, 97201, US

(73) Assignee: Avenue A, Inc.

(21) Appl. No.: 09/781,742

(22) Filed: Feb. 12, 2001

(51) Int. Cl. G06F 17/60; H04K 1/00; H04L 9/00; H04L 9/32; G06F 11/30; G06F 12/14

(52) U.S. Cl. 705/51; 705/14; 713/201

(57) ABSTRACT

A method and facility for commercial Internet-based communication with a user includes a first entity receiving a web browsing activity communication from the user along with a unique device identifier. A second entity receives a user communication address and the first identifier from the user. The first entity transmits to the second entity a resulting communication such as an email solicitation intended for the user along with the first identifier. The communication may be based on the web browsing activity. The second entity transmits the resulting communication to the user communication address. The web browsing data and the communication address are maintained securely and separately, so that no one entity has access to both set of data.

### FIELD OF THE INVENTION

This invention relates to internet communication, and more particularly to commercial and advertising communication methods that employ detailed user activity information while preserving user privacy.

### BACKGROUND AND SUMMARY OF THE INVENTION

The Internet is an effective tool for commercial communication. Companies use electronic communications to consumers to cost effectively promote their goods or services. A customer may provide his contact information to a company so that he or she may be sent promotional communications. The contact information may be an email address, a physical street address, a telephone number, or any other information that allows the company to transmit promotional information or advertisements.

Companies can improve the effectiveness of their promotions by targeting or tailoring them to the particular customers. Internet companies can readily gather limited anonymous information from visitors to digital properties (such as web sites), including recording the pages and advertisements viewed by the user, along with any other IP based activity (this covers HTTP (internet), smtp, and other IP based protocol). This information may be collected over time, from visits to many different digital properties, and may paint a detailed anonymous portrait that is useful in determining whether and with what promotional content to communicate. Such browsing information gathered about the user's browsing and other Internet activity lacks the means to contact the user. The gathered information is identified by a unique device identifier such as a “cookie” associated with either the device (if there are no profiles on the device) or the user's profile on the device used by the user for browsing, but this cookie does not identify the user, his email address, or any other information. IN the preferred embodiment, this is merely a numeric identifier that is useful for identifying all the different browsing sessions conducted by the same user in domains where the communication service company is serving content into, and it is impossible to determine from the identifier the identity or location of the person using the device. Once assigned the identifier may also be used so that subsequent visits may be correlated with earlier visits to identify patterns, or to select which advertisements are served to the still-anonymous visitor.

Therefore, it is necessary for a web site operator seeking to later contact a user to invite the user to voluntarily provide address or other contact information. Once provided, the address is associated with the cookie or other persistent identifier in the database of the company or its agent, enabling transmission to that address of communications selected based on the browsing data associated with that user's device.

While this approach is effective, some users are concerned about privacy issues. Even a user who trusts a particular familiar company not to disclose or misuse address information under normal circumstances may have concerns in the web browsing context. This concern can arise because of the body of data collected on his or her web browsing activity across many sites, which may then be connected to his or her personal identifying information. It is even possible that the user may wish to receive information from an organization he does not entirely trust (such as a person seeking information about sensitive medical or financial questions.) Consequently, many potential customers opt not to provide their contact information, and companies lose these commercial opportunities that those customers would otherwise have desired. Accordingly, there is a need for a system that allows companies to collect personal information needed to send messages, without the user being required to trust the company with that information.

The present invention overcomes the limitations of the prior art by providing a method and facility for commercial Internet-based communication with a user. The method includes a first entity receiving a unique identifier for the user within the first entity domain and a unique identifier for the user within the second entity domain. The first entity captures web browsing activity communication from the user with the user's unique identifier within the first entity domain. A second entity receives a user communication address along with a unique identifier for the user within the second entity domain. The first entity transmits to the second entity a resulting communication such as an email solicitation intended for the user along with the user's identifier within the second domain. The communication may be based on the web browsing activity. The second entity transmits the resulting communication to the user communication address. The web browsing data and the communication address are maintained securely and separately, so that no one entity has access to both set of data.

### BRIEF DESCRIPTION OF THE DRAWINGS

FIG. 1 is a schematic block diagram showing the system and method of operation according to a preferred embodiment of the invention.

### DETAILED DESCRIPTION OF A PREFERRED EMBODIMENT

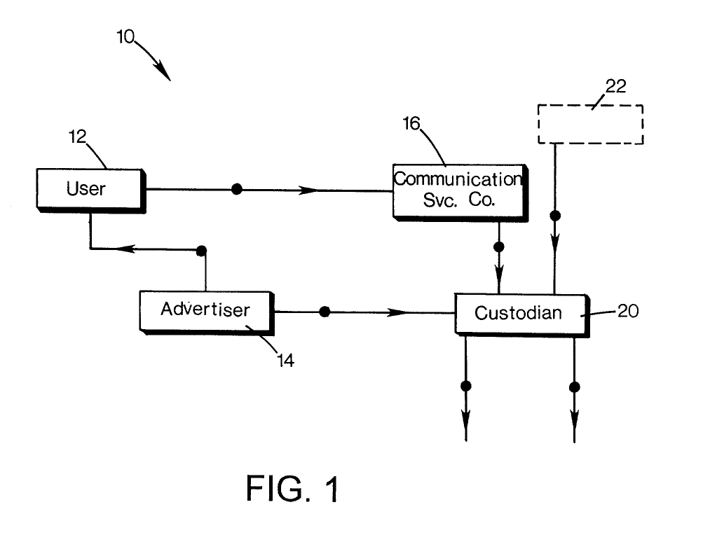

FIG. 1 shows an electronic communication system 10, operating in the environment of the Internet or other communication network. The diagram shows an Internet customer or user computer system 12. The Internet customer preferably uses one such Internet customer computer system to connect, via the Internet, to an Internet publisher or advertiser computer system 14, to retrieve and display a Web page.

Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities. When entities are described as being connected to the Internet, it is understood that the company maintains computer servers and other suitable equipment for communicating with other entities via the Internet.

An Internet communication service company (CSC) 16 is also connected to the Internet, and provides certain services to the advertisers and publishers. Such services may include placement of advertisements on the publisher's digital property, consulting services for placement of the advertiser's advertisements on other advertising digital properties, and collection and analysis of information about the advertisers and publishers customers and visitors to the advertisers and publishers digital properties. Advertisements may come in various formats, such as email text, email html, banner, globe etc. Publishers may sell space on various media, such as email, web pages, search results, newsletters etc.

A custodian company 20 is connected to the Internet for communication with the communication service company 16 and the publisher 14. The custodian maintains a secure database that is inaccessible to other entities, so that private and personal information transmitted to and stored by the custodian is inaccessible to all other parties, and may be utilized directly only by the custodian.

Each entity in the above system typically includes one or more central processing units (CPUs) for executing computer programs such as the facility described below, a computer memory for storing programs and data, and a computer-readable media drive, such as a CD-ROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

The process of operation of the facility involves the visit by the user 12 to the advertiser's 14 digital property, the user being invited to provide address information to enable the advertiser to send future promotions, the collection of web browsing data from the user by the communication service company 16, and the transmission of the personal data to the custodian (typically via the advertiser, which initially collects the personal data). A message is later generated to the user based on the collected web browsing data, and the custodian essentially addresses that message to the user by generating and transmitting a message using the personal data provided by the customer.

First, a user visits the advertiser's digital property. In one example, the advertiser may be an Internet retailer, and the user is browsing the site looking at various product offerings. The user may make multiple visits to the site. During these visits, the user is essentially anonymous, in that the site has no way of knowing who is visiting the site, where their computer is located, what is the user's email of street address, or any other personally identifiable information (PII). The site (publisher or advertiser) (or its agent 16) is able to collect very detailed information about the user's web browsing activity within the their own domain. However, this is identified only with either the unique device identifier (e.g. cookie) associated either with the user's profile on the browsing device or with the user's browsing device, or preferably, by a Communication Service Company ID (CSCID) generated by the CSC, and transmitted to the user's computer, where it is stored for use by the CSC to identify the user's computer on subsequent visits, to any digital property with which the CSC is associated.

Thus, the advertiser, publisher, or CSC may recognize that the same user (of unknown identity) has returned to their domain for a second visit, for instance. And the communication service company may collect this same data in conjunction with the advertiser or publisher, and index it in a database based on the CSCID or cookie, so that the user's visits to innumerable other digital properties of other advertisers and publishers are cataloged based on the one CSCID or cookie. Eventually a detailed portrait of the user (or at least of all users of that particular user's computer (if all users on the computer share the same profile) is generated. This portrait, even though it is still not identified with any particular identifiable user, may contain information useful to the advertiser or publisher for marketing purposes, but which is useful for generating promotional messages to the user only if a contact address can be associated with the information.

The advertiser or publisher requests such a contact address of the user. The request may come initially, such as when a user is required to register before gaining entry to a site (e.g. for downloading newspaper articles from a national newspaper site.) The request may come after the user has actively browsed, such as when providing shipping and billing address information for an on-line retail purchase. In any event, the provision of this personal information is purely voluntarily, and the user is well aware that the information is being collected, by whom and will be used to contact the user. This is considered an “opt-in” system, in which the user must take positive action before knowingly transmitting the personal information.

The personal information may include name, street address, email address, user URL, telephone numbers, and any other identifier useful for getting a communication to that user.

When the user opts in on a advertiser's or publisher's site to accept email, his history of anonymous web browsing activities and click stream that the communication service company (and/or others) has captured or gathered may be employed to generate messages to that user.

The advertiser or publisher (or its selected agent such as the CSC) receives the personal information. The LUID serves to identify the user, and is associated with the personal information by the advertiser or publisher.When the user's computer and browsing software requests a page to be downloaded, the page loads with the content from the advertiser or publisher and the action tag content that points the user's browser to the communication service company's domain, then the user opts in and submits their communication data to the advertiser or publisher, the advertiser or publisher saves the communication data associated with that user's the advertiser or publisher LUID, the advertiser or publisher programmatically appends the LUID to the CSC extended data action tag and then this data is submitted to the CSC server. With this communication of the LUID, the user's CSCID or device cookie is also collected, if it has not already been collected.

The communication service company now stores the LUID in a database record with the cookie, and with all browsing activity associated with the cookie, so that all the information is associated (excluding the personal information, which the publisher has not communicated to the communication service company.) By receipt of the LUID generated by the publisher, the CSC knows that there is contact address information now in existence (at the custodian) for a user associated with the cookie or CSCID under which profile information is stored.

The publisher then transmits the user's personal information together with the associated LUID to the custodian, either immediately, or in an occasional bulk transmission of user data. The custodian stores each user's information, indexed by the LUID, in a secure database to which no outside parties have access.

The system has now completed its gathering and storage of user information. Further browsing activity information by the user may be collected by the CSC, and stored with other information associated with the CSCID, until a satisfactory profile of the user is generated. The CSC uses the CSCID to access the user's anonymous browsing profile, and creates segments of users based on their anonymous browsing profiles. These segments preferably have common characteristics of browsing history that suggest that a particular promotional communication will be fruitful. For instance, users who are identified as having browsed and shopped at a retailer, selecting items for a “shopping cart”, but never having made the purchase, might be targeted with an email offering them the selected items at a discount. Innumerable alternative marketing strategies may be employed.

For each user selected to receive a given promotion, the CSC identifies the CSCID, and looks up the associated LUIDs. The CSC generates a communication package to the custodian. The package may be in the form of the message content, plus the list of the LUIDs of all who are the intended recipients. In this case, the custodian essentially serves as a mailing service, looking up the personal address information associated with each LUID, and sending the message content to that address. This approach is useful when each user receives a custom message, each of which might relate to a different particular item or discount level based on past recorded activity. Where the users in the segment are all selected to receive the same message, the custodian need not receive the message, but may instead receive the list of LUIDs from the CSC, and return a list of address information (such as email addresses.) This returned list is arranged in no particular order, and must be of adequate size so that it would be impractical to guess at which LUID correlates with which personal address information. A CSC and custodian may establish minimum standards for group size needed to adequately assure anonymity.

The CSC can enhance its database of user profiles by receiving more digital data from other CSCs 22, publishers, and other entities. These may include digital call centers, other online companies or other online publishers. By using extended action tags the CSC can link different LUIDs for the same user across different domains. So for each user, the information collected by one entity from one domain may be linked to other information received by another entities on another domains. For instance, an email received from one publisher may be linked to a telephone number, name, or street address from another publisher. Then, a single publisher or CSC desiring a promotion may use information provided to a different publisher (e.g. sending a postcard to an online customer who gave only his email address to the particular publisher, but who gave the street address to another publisher.)

In addition, the custodian may link the user's anonymous activity information across multiple different platforms (e.g. web browsing from various locations, wireless telephone, etc.)

The custodian may also offer internet enhanced profiles to other companies (catalog companies, call centers, online companies etc.) For example, a name, address, phone number, or credit card number may be used to link a user's digital profile to it's old world profiles in call centers and catalog companies. Thus, a call center could hand over a list of customer LUIDs to the CSC, which could inform advertisers which of their customers have hit their online site or their competitors online site and so the call center could then call the customer and encourage them to shop on line by offering them a discount. Also, by combining offline and online behavior, this data may provide valuable commercial insights to advertisers and/or publishers.

Preferably, to enhance a user's awareness of the trustworthiness of the above system, and particularly of the custodian (or CSC and/or publisher associated with the custodian), a symbolic indicia is displayed by the publisher on the web page at which personal information is requested. The indicia preferably includes textual or symbolic indicators of trust, safety, security, and/or privacy, and may be identified as a certification mark to ensure that the good will and reputation for trustworthiness and security accrues only to the entities involved, or to entities who meet the standards established by a certifying agency.

While the above is discussed in terms of preferred and alternative embodiments, the invention is not intended to be so limited.

1. A method of commercial Internet-based communication with a user, comprising:
a first entity receiving from the user a web browsing activity communication and a first identifier;
a second entity receiving from the user a user communication address and the first identifier;
the first entity transmitting to the second entity a resulting communication intended for the user and the first identifier; and
the second entity transmitting the resulting communication to the user communication address.

2. The method of claim 1 wherein the first entity is an Internet advertising service entity.

3. The method of claim 1 wherein the first identifier is a unique device identifier.

4. The method of claim 1 including the first entity receiving a site identifier associated with a digital property visited by the user, and the second entity receiving the user communication via a third entity associated with the digital property.

5. The method of claim 1 wherein the user communication address is an email address.

6. The method of claim 1 wherein the user communication address includes personal information identifying the user.

7. The method of claim 1 wherein the second entity is a separate entity from the first entity.

8. The method of claim 1 including the second entity securing the user communication address to prevent access by the first entity to the user communication address.

9. The method of claim 1 including a third entity collecting the user communication address, and displaying indicia associated with at least one of the first entity and the second entity in conjunction with the collection of the user.

10. The method of claim 9 wherein the indicia includes an assurance of personal data security to the user.

11. The method of claim 1 wherein the resulting communication is a commercial promotion.

12. The method of claim 1 including the first entity generating the resulting communication at least in part based on the web browsing activity communication.

13. The method of claim 1 including the first entity retrieving a database record associated with the first identifier.

14. The method of claim 13 wherein the database record includes information about prior web browsing activity associated with the first identifier.

15. A method of commercial Internet-based communication with a user, comprising:
collecting Internet activity information about the user;
storing the information at a first location;
receiving personal identifying information about the user; and
directing the personal identifying information to a custodian separate from the first location.

16. The method of claim 15 including generating a communication to the user based on the Internet activity information, transmitting the communication to the custodian for transmission to the user.

17. The method of claim 15 including collecting a unique device identifier in conjunction with collecting Internet activity information, and wherein receiving personal identifying information includes receiving the unique device identifier.

18. The method of claim 15 including segregating the Internet activity information from the personal identifying information to prevent access by a common entity.

19. The method of claim 15 wherein receiving personal identifying information about the user includes inviting the user to provide the receiving personal identifying information, and displaying indicia associated with the custodian.

20. An Internet computer system comprising:
a first storage facility containing Internet activity information associated with an identifier;
a separate second storage facility containing address information associated with the identifier;
a message generator operable to generate a message based on the Internet Activity information;
a message transmission connection between the first facility and the second facility; and
a message addressing facility connected to the second storage facility operable to retrieve and apply the address information to the message.
